(19) United States
(12) Patent Application Publication
(10) Pub. No.: US 2026/0023350 A1
(43) Pub. Date: Jan. 22, 2026

(54) SAFETY CONTROL FOR A PROCESS CONTROL SYSTEM

(71) Applicant: ABB Schweiz AG, Baden (CH)

(72) Inventor: Zhibo Pang, Västerås (SE)

(21) Appl. No.: 18/997,139

(22) PCT Filed: Jul. 21, 2022
(86) PCT No.: PCT/EP2022/070487

§ 371 Date: Jan. 20, 2025

(51) Int. Cl. G05B 9/02

(52) U.S. Cl. CPC G05B 9/02

(57) ABSTRACT

A process control system includes an automation device, an automation function environment including a process control function, a hardware assigning unit and hardware for functions of the automation function environment, the process control function controlling the automation device using control signals in a control signal path through a wireless network and employing hardware in the automation function environment assigned by the hardware assigning unit. At least one safety actuator and at least one safety sensor are placed together in the automation function environment and/or a control signal path environment and a primary hardware entity implementing a safety control function obtains safety data from the safety sensor about the safety of the corresponding environment, determines the safety of the corresponding environment based on the safety data and performs a safety activity using the safety actuator if safety is insufficient.

### TECHNICAL FIELD

The present disclosure relates to a process control system as well as to a method for investigating safety in the process control system.

### BACKGROUND

With the introduction of cloud and edge computing, process control functions can be placed in the cloud or in an edge node. The process control function may then communicate with an automation device in which process control is performed via a wireless network. Thereby purpose-specific industrial controllers such as Programable Logic Controllers (PLC) can be replaced by process control functions in the edge or cloud.

One example on this can be seen in US 2013/0211559, which discloses the use of a cloud service in the form of a control application that generates and delivers control instructions to industrial devices in industrial facilities based on analysis of near real-time system data.

Industrial PC (IPC), or Programmable Automation Controller (PAC) can increase the deployment flexibility and reduce capital expenditure of end users. Moreover, through combining the edge/cloud computing with low latency and high reliability wireless networks, such as 5G or WiFi 6 and their succeeders, to replace the wired networks these benefits can be further enlarged. However, all these benefits must be delivered without compromise in functional safety.

There is therefore a need for providing safety control with a sufficient degree of safety for a process control system that has been moved to the edge or the cloud.

### SUMMARY

One objective of the invention is therefore to provide safety control with a sufficient degree of functional safety together with process control, when the process control is performed from an automation function environment via a wireless network.

According to a first aspect there is presented a process control system comprising:
an automation device;
an automation function environment comprising a process control function, a first hardware assigning unit and hardware for functions of the automation function environment, where the process control function controls the automation device using control signals sent in a control signal path through a wireless network and employing hardware in the automation function environment that has been assigned to the process control function by the first hardware assigning unit;
a group of safety field devices comprising at least one safety actuator and at least one safety sensor placed together in the automation function environment and/or in a control signal path environment in the wireless network; and
a primary hardware entity implementing a safety control function;
said safety control function being configured to obtain safety data from the at least one safety sensor about the safety of the corresponding environment, determine the safety of the corresponding environment based on the obtained safety data and perform a safety activity using the at least one safety actuator in case the safety of the corresponding environment is found to be insufficient.

According to a second aspect, there is provided a method for investigating safety in a process control system, the process control system comprising
an automation function environment in contact with an automation device via a wireless network, where a process control function in the automation function environment controls the automation device using control signals sent in a control signal path through the wireless network and employing hardware in the automation function environment that has been assigned to the process control function by a first hardware assigning unit; and
a group of safety field devices comprising at least one safety actuator and at least one safety sensor placed together in the automation function environment and/or in a control signal path environment in the wireless network;
   the method comprising:
obtaining, from the at least one safety sensor, safety data about the safety of the corresponding environment;
determining the safety of the corresponding environment based on the obtained safety data; and
performing a safety activity using the at least one safety actuator in case the safety of the corresponding environment is found to be insufficient.

The control signal path environment may comprise a base station through which the control signal path passes.

The safety data may comprise data about abnormal consumption of processing power and or memory resources, data about detected abnormal increasing temperature levels or temperature changes, data about detected fire or smoke in the corresponding environment, data about physical intrusion and/or damage to the corresponding environment and/or virtual intrusion detected by firewalls of the corresponding environment.

The safety activity, which is performed in the environment in which the safety actuator is placed, may comprise stopping or rebooting hardware or software in the environment, sending alarm messages to maintenance personnel and/or activating redundant/backup hardware and/or software.

The at least one safety sensor may comprise a first safety sensor in the automation function environment and the at least one safety actuator may comprise a first safety actuator in the automation function environment.

In this case the obtaining of safety data about the safety of the corresponding environment may comprise obtaining of safety data from the first safety sensor, the determining of the safety of the corresponding environment may comprise determining the safety of the automation function environment and the performing of a safety activity using the safety actuator in case the safety of the corresponding environment is found to be insufficient comprises performing a safety activity using the first safety actuator if the safety of the automation function environment is found to be insufficient.

A first secondary hardware entity may be provided in the automation function environment for sensor handling functionality of the first safety sensor. It is additionally possible that the first secondary hardware entity has been assigned to the sensor handling functionality by the first hardware assigning unit. A second secondary hardware entity may likewise be provided in the automation function environment for actuator functionality of the first safety actuator. In this case it is also possible that the second secondary hardware entity has been assigned to the actuator functionality by the first hardware assigning unit.

The at least one safety sensor may also comprise a second safety sensor placed in the control signal path environment and the at least one safety actuator may in this case comprise a second safety actuator placed together with the second safety sensor in this control signal path environment.

In this case the obtaining of safety data about the safety of the corresponding environment may comprise obtaining of safety data from the second safety sensor, the determining of the safety of the corresponding environment may comprise determining the safety of the control signal path environment and the performing of a safety activity using the safety actuator in case the safety of the corresponding environment is found to be insufficient comprises performing a safety activity using the second safety actuator if the safety of this environment is found to be insufficient.

A first tertiary hardware entity may be provided in the control signal path environment for sensor handling functionality of the second safety sensor. It is additionally possible that the first tertiary hardware entity has been assigned to the sensor handling functionality by a second hardware assigning unit of the wireless network. A second tertiary hardware entity may additionally be provided in the control signal path environment for actuator functionality of the second safety actuator. It is in this case also possible that the second tertiary hardware entity has been assigned to the sensor handling functionality by the second hardware assigning unit.

The safety control function may be operating in parallel with the process control function.

The first hardware assigning unit may be implemented using hardware in the automation function environment.

The process control system may comprise a wired safety network. It is additionally possible that the hardware implementing the safety control function is connected to the wired safety network.

The automation device may employ a wired network interface to the wired safety network. It may also employ a first interface to the wireless network.

The process control system may comprise a second interface to the wireless network for the wired safety network, which second interface may be of a first type that is an interface to a backbone network of the wireless network or of a second type that is an air interface to the wireless network, such as an air interface to a base station of the wireless network.

The process control system may further comprise a safety controller comprising the primary hardware entity implementing the safety function. Alternatively, the primary hardware entity may be provided in the automation function environment. In this case it is additionally possible that the primary hardware entity has been assigned to the safety function by the first hardware assigning unit.

The automation function environment may be a virtual cloud-based automation function environment where the process control function is a virtual controller, possibly also the safety control function is a virtual controller and the hardware assigning unit implements a virtualization layer, while the first automation device may be a real automation device. Alternatively, the automation function environment, the process control function and possibly also the safety control function may be provided in an edge node communicating with the automation device.

The wireless network may be a part of the process control system or external to the process control system.

At least one further safety field device in the group of safety field devices may be a wired safety field device connected to the wired safety network Alternatively or in addition, at least one further safety field device in the group of safety field devices may be a wireless safety field device.

When the primary hardware entity is provided in the automation function environment, it is additionally possible that at least one of the further safety field devices is a safety actuator that is configured to cause the automation device to enter a safe state if losing contact with the automation function environment.

The safety control function may additionally perform a safety activity for the automation device using a further safety actuator of the at least one further safety field device in case the safety of a corresponding environment is found to be insufficient, which safety activity may comprise placing the automation device in a safe state.

The automation device may be any type of device that is used in control system such as a robot, a relay, a valve, a power switch, a conveyer belt, a motor, a drive, an I/O module, a sensor or an actuator.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a diagram schematically illustrating a first embodiment of a process control system comprising an automation function environment, an automation device environment and a safety controller, where the automation function environment communicates with the automation device environment via a wireless network,

FIG. 2 is a flowchart schematically illustrating a number of method steps for investigating safety in the process control system and being performed by a safety control function of the safety controller,

FIG. 3 is a diagram schematically illustrating a second embodiment of a process control system comprising the automation function environment, the automation device environment, the safety controller and the wireless network,

FIG. 4 is a diagram schematically illustrating a third embodiment of a process control system comprising the automation function environment, the automation device environment, the safety controller and the wireless network, and

FIG. 5 is a diagram schematically illustrating a fourth embodiment of a process control system comprising the wireless network, the automation device environment and an automation function environment with a safety control function.

### DETAILED DESCRIPTION

Aspects of the present disclosure will now be described more fully hereinafter with reference to the accompanying drawings, in which certain embodiments are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

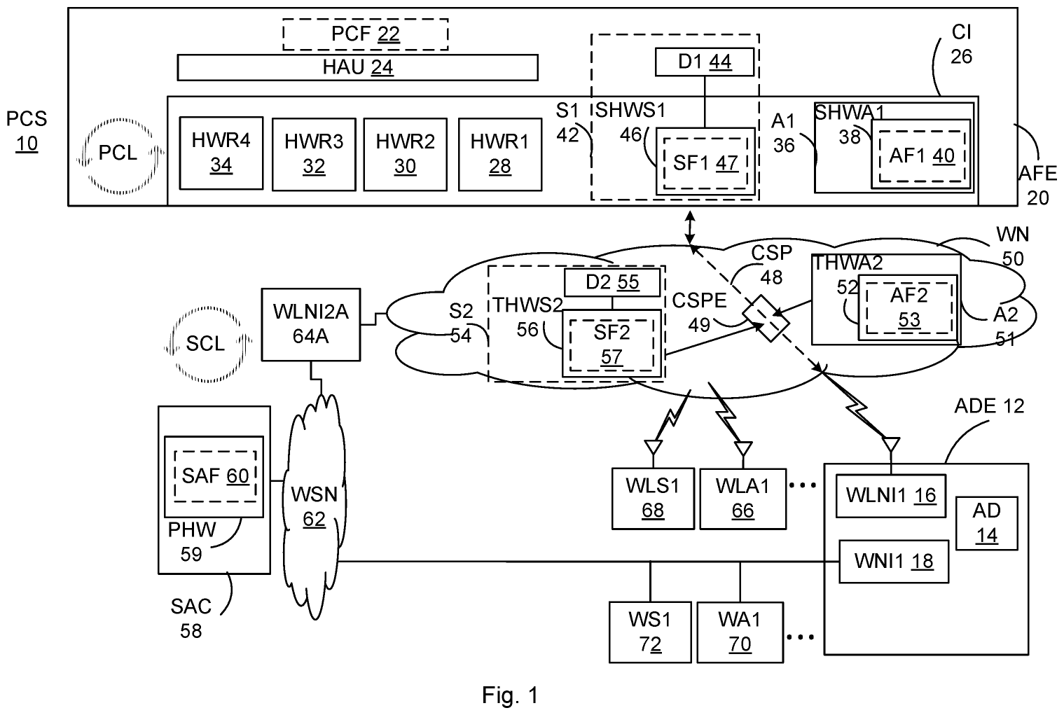

FIG. 1 is a diagram schematically illustrating a first embodiment of a process control system PCS 10, which process control system 10 comprises an automation device environment ADE 12, an automation function environment AFE 20 as well as a safety control system comprising a safety controller SAC 58. Moreover, the automation function environment 20 is in contact with the automation device environment 12 via a wireless network WN 50, which may be realized through an external wireless network, such as a public wireless network, or an internal wireless network, i.e. a wireless network that is a part of the process control system 10. The automation function environment 20 may be connected to a backbone network of the wireless network 50 or it may have a wireless connection to the wireless network 50. Furthermore, the wireless network 50 may be a deterministic network, i.e. a network where the delay or latency is limited through the network guaranteeing that messages are being transferred in a set time period.

The automation function environment 20 comprises a computing infrastructure CI 26 and a first hardware assigning unit HAU 24. The automation function environment 20 may as an example be a cloud-based automation function environment comprising virtual controllers, while the automation device environment 12 is a real automation environment comprising an automation device 14 that is a real automation device. In this case the computing infrastructure CI 26 may be a cloud computing infrastructure and the first hardware assigning unit HAU 24 may be a virtualization layer for virtualizing cloud functionality. The computing infrastructure 26 comprises a first hardware resource HWR1 28, a second hardware resource HWR2 30, a third hardware resource HWR3 32 and a fourth hardware resource HWR4 34. The hardware resources 28, 30, 32, 34 may comprise both processing and memory resources, such as processing blades and memory blades. It may also comprise more or fewer hardware resources. The automation function environment 20 also comprises a process control function PCF 22. The process control function 22 may be realized as a virtual controller implemented using the computing infrastructure 26 based on a mapping made by the first hardware assigning unit 24 to hardware of the computing infrastructure 26. The process control function 22 may be assigned to any of the hardware resources 28, 30, 32, 34. As an example the process control function 22 may be assigned to the first hardware resource 28.

Alternatively, the automation function environment 20 and the process control function 22 may be provided in an edge node communicating with the automation device environment 12.

The process control function 22 may control one or more automation devices in the automation device environment 12. As an example, the process control function 22 controls the automation device 14 in the automation device environment 12 using control signals sent in a control signal path CSP 48 through the wireless network 50.

In order to enable the above-mentioned control, the automation device environment 12 also comprises a first wireless network interface WLNI1 16 for wireless communication with the wireless network 50, such as for wireless communication with a base station of the wireless network 50. In this first embodiment of the process control system 10, the automation device environment 12 also comprises a first wired network interface WNI1 18, which is a first interface to a wired safety network WSN 62 of the safety control system. The automation device 14 may employ the first wired network interface 18 for communication with the safety controller 58. The first wireless network interface 16 and the first wired network interface 18 may be common interfaces used for all automation devices in the automation device environment or be dedicated to the automation device 14. They may even be included in the automation device 14.

The process control system 10 comprises a group of safety field devices which safety field devices are also a part of the safety control system. The group of safety field devices comprises safety field devices in the automation device environment 20 and/or the wireless network 50 as well as possibly also a number of wired safety field devices and a number of wireless safety field devices.

In the first embodiment of the process control system 10, the safety controller 58 is realized through a dedicated primary hardware entity PHW 59 implementing a safety control function SAF 60. In the first embodiment of the process control system, the safety controller 58 is connected to the wired safety network 62 and to the number of wired safety field devices via the wired safety network 62, where the wired safety field devices comprise a first wired safety actuator WA1 70 and a first wired safety sensor WS1 72. The wired safety network 62 also has a first type of a second wireless network interface WLNI2A 64A, which is a second interface to the wireless network 50. In this first embodiment of the process control system the first type of second wireless network interface 64A is an interface to a backbone network of the wireless network 50.

The first type of second wireless network interface 64A can be realized through, 1) the User Plane Function (UPF) of Base Stations if the Wireless Network 50 is based on 3GPP 4G, 5G, or beyond, or 2) an Ethernet interface if the Wireless Network 50 is based on WiFi4, WiFi5, WiFi6 or beyond. As an alternative the wired safety network 62 can be connected to the wireless network 50 through a second type of interface, which may be realized through, 1) a user equipment if the wireless network 50 is based on 3GPP 4G, 5G, or beyond, or 2) a station if the wireless network 50 is based on WiFi4, WiFi5, WiFi6, or beyond.

The number of wireless safety field devices comprises a first wireless safety actuator WLA1 66 and a first wireless safety sensor WLS1 68. Although the wireless and wired safety field devices 66, 68, 70, 72 are shown as being located outside of the automation device environment 12, it should be realized that one or more and possible all of these safety field devices may just as well be located inside the automation device environment 12 physically close to the automation device 14.

The automation device environment 12 can be connected to the wired safety network 62 directly through the first wired network interface 18, or it can also be connected to the wired safety network 62 indirectly through the wireless network 50 using the first wireless network interface 16. For the former case, the automation device environment 12 uses the first wireless network interface 16 for process control traffic and the first wired network interface 18 for safety control traffic. For the latter case, the automation device environment 12 uses the first wireless network interface 16 for both safety and process control traffic.

As can be seen in FIG. 1, the automation function environment 20 comprises a first safety sensor S1 42 and a first safety actuator A1 36, which are thus placed together in the automation function environment 20. The first safety sensor 42 is intended to be used together with the first safety actuator 36. The first safety sensor 42 comprises a first secondary hardware entity SHWS1 46 as well as a first sensor function SF1 47 implemented using the first secondary hardware entity 46. The first sensor function 47 provides sensor functionality for the first safety sensor 42. The first safety sensor 42 may optionally also comprise a first detector D1 44, such as a temperature and/or a fire detector from which the first sensor function 47 may collect sensor data, such as data of a measured physical property in the automation function environment 20. The first secondary hardware entity 46, which in this case is dedicated to the first sensor function 47, may be provided in the computing infrastructure 26, while the first detector 44 may be provided outside of it. The first safety actuator 36 may in a similar manner be provided through a second secondary hardware entity SHWA1 38 for a first actuator function AF1 40, which provides actuator functionality for the first safety actuator 36. It should be realized that as an alternative to using dedicated hardware, the first actuator function 40 and the first sensor function 47 may be assigned to a hardware resource by the first hardware assigning unit 24.

Moreover, also the wireless network comprises safety field devices comprising a second safety sensor S2 54 and a second safety actuator A2 51, where the second safety sensor 54 is intended to be used together with the second safety actuator 51. The second safety sensor 54 and the second safety actuator 51 may be placed together in an environment 49 of the control signal path 48 in the wireless network, such as in a base station that the control signal path 48 passes. This environment 49 will in the following be termed a control signal path environment CSPE. The second safety sensor 54 may in a similar manner comprise a first tertiary hardware entity THWS2 56 as well as a second sensor function SF2 57 implemented using the first tertiary hardware entity 56 and an optional second detector D2 55, where the second sensor function 57 provides sensor functionality for the second safety sensor 54. The second safety actuator 51 may in a similar manner be provided through a second tertiary hardware entity THWA2 52 where a second actuator function AF2 53 is implemented, where the second actuator function 53 provides actuator functionality for the second safety actuator 51. The first and second tertiary hardware entities 56,52 for the second safety sensor 54 and the second safety actuator 51 may be provided as dedicated processors and memories in equipment of the wireless network 50, such as in base stations of the wireless network. As an alternative, the second actuator function 53 and the second sensor function 57 may be assigned to a hardware resource by a second hardware assigning unit of the wireless network 50, which hardware resource may be located in a base station through which the control signal path 48 passes between the automation device environment 12 and the automation function environment 20.

It should be realized that it is possible that the process control system 10 comprises the first safety sensor 42 and the first safety actuator 36 but not the second safety sensor 54 nor the second safety actuator 51. Alternatively, the process control system 10 may comprise the second safety sensor 54 and the second safety actuator 51 but not the first safety sensor 42 nor the first safety actuator 36.

The first and second safety sensors 42 and 54 may monitor unexpected damage, destruction, or anomaly of the corresponding environment, e.g., abnormal consumption of CPU/memory/storage, detected abnormal increasing of temperature, fire or smoke at the environment, physical intrusion/damage to the environment, virtual intrusion detected by firewalls, etc. The first and second safety actuators 36 and 51 may respond to commands from the safety control function, e.g., to stop or reboot the respective hardware and/or software module, to send alarm messages to maintenance personnel, to activate redundant/backup hardware and/or software modules, etc., where the software module in the case of the automation function environment is a software module implementing the process control function and in the software module in the case of the control signal path environment is a software module with software involved in the routing of signals through the wireless network.

As an example, the communication protocol used between the safety controller 58 and the safety sensors and actuators may follow one of the standards defined in IEC 61784-3, including but not limited to PROFIsafe, openSAFETY, CIP Safety, FSoE, CC-Link IE Safety, OPC UA Safety, etc.

In operation the process control function 22 has been assigned hardware, such as the first hardware resource 28. The process control function 22 is thus being run in a virtual machine, for instance as a virtual safety controller, on the assigned hardware 28 and then controls the automation device 14 in a process control loop PCL via control signals in the control signal path 48 through the wireless network 50. This may involve the process control function 22 receiving a control signal via the control signal path 48 in the form of a sensor measurement from a sensor in or at the automation device environment 12, determine a control command for the automation device 14 and send the control command in the control signal path 48 as a control signal used to control the automation device 14. In this control these control signals may additionally pass through the control signal path environment 49, which control signal path environment 49 may comprise a node of the wireless network 50, such as a base station, in which the second safety actuator 51 and the second safety sensor 54 are provided.

In the automation device environment 12, the traditional hardware controllers in the field are removed. Instead, control logic is executed by automation functions, e.g. soft controllers, hosted by processing and memory hardware in the computing infrastructure 26, which can be realized by the ABB Ability, GE Predix, Siemens MindSphere, Microsoft Azure, Amazon Web Services, Alibaba Cloud, Huawei Mobile Cloud, etc. The control logic of the automation functions can be programmed in the PLC-specific languages such as IEC61131-3 and IEC61499, or generic programming languages such as C/C++. The computing infrastructure 26 can also be shared with other applications. The process control function 22 is thus not performed by any hardware controller close to the automation device 14 but by a soft controller implemented through the hardware resource 28 assigned by the first hardware assigning unit 24. The process control function 22 may thereby be hardware agnostic, i.e., it may be realized in the virtualized computing infrastructure 26 over the first hardware assigning unit 24, such as with Docker containers and/or virtual machines of Linux, Windows, VxWorks, etc.

In parallel with the process control being performed by the process control function, the safety controller 58 performs safety control in a safety control loop SCL.

In this first embodiment, the safety control loop is controlled by the dedicated hardware safety controller 58 in the field, which safety controller 58 comprises the primary hardware entity 59 with the safety control function 60. The safety controller 58 communicates with the wired safety field devices 70 and 72 using the wired safety network 62. However, it can also communicate with the wireless safety field devices 66, 68 over the wireless network 50, where the wireless network 50 may be qualified to elaborate a black channel for a safety communication layer according to the IEC61508. The two control loops merge at the automation device 14 in the automation device environment 12, which automation device 14 can be any type of device that is used in process control systems such as a robot, a relay, a valve, a power switch, a conveyer belt, a motor, a drive, an I/O module and any other sensor or actuator.

The safety control involves the safety controller 58 receiving sensor measurements from safety sensors, such as the first wireless and wired safety sensors 68 and 72, determining if there is a fault and/or a hazard in the automation device 14 or the automation device environment 12 based on these sensor measurements and performing a safety activity if the safety is deemed to be compromised, where the safety activity may involve placing the automation device in a safe state. This type of traditional safety control is based on monitoring the automation device environment. However, as the control is carried out from the automation function environment 20 via the control signal path 48 through the wireless network 50, also the automation function environment and the control signal path environment 49 may cause safety issues.

Aspects of the present disclosure are directed towards addressing this issue.

Compared with the traditional closed and dedicated computing infrastructure and wired or wireless network for functional safety, the automation function environment 20 and the wireless network 50 are subject to higher uncertainties due to their open and shared nature. To inspect the safety integrity of the automation function environment 20 and the wireless network 50, the first safety sensor 42 and the first safety actuator 36 are added into the computing infrastructure 26 and/or the second safety sensor 54 and second safety actuator 51 are added into the control signal path environment 49.

The safety logic executed by the safety control function 60 may therefore periodically scan not only the wireless and/or wired safety sensors 68, 72 and wireless and/or wired safety actuators 66, 70, but also the first safety sensor 42 and first safety actuator 36 in the automation function environment and/or the second safety sensor 54 and second safety actuator 51 in the control signal path environment 49.

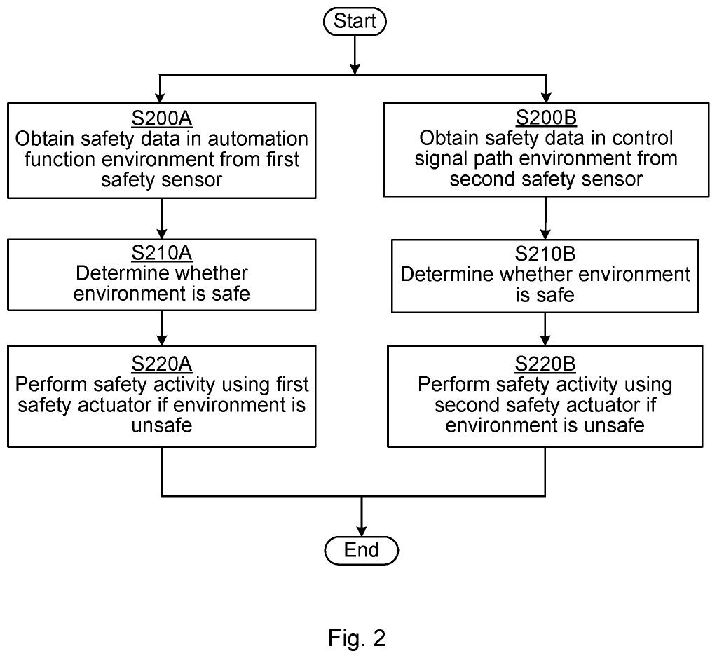

How safety may be improved using the first and second safety sensors and the first and second safety actuator will now be described with reference being made to FIG. 2, which shows a number of steps in a method of investigating safety in the process control system being performed by the safety control function 60.

The safety investigation may comprise performing two parallel safety control loops, where a first safety control loop is performed with regard to the automation function environment 20 and the second safety control loop is performed with regard to the control signal path environment 49. The first safety sensor 42 may continuously provide safety data to the safety control function 60, for instance as a measured physical property like temperature or smoke or fire that is detected by the first detector 44. The safety data may also comprise safety data concerning the operation of hardware and software running the process control function 22. The safety data may also comprise data about physical intrusion and/or damage to the automation function environment 20 and/or virtual intrusion detected by firewalls of the automation function environment 20. Thereby the safety control function 60 obtains safety data from the first safety sensor 42, S200A, which safety data concerns the safety of the automation function environment 20. The safety control function 60 then determines whether the corresponding automation function environment 20 is safe, S210A. It thus determines the safety of automation function environment based on the obtained safety data. This may be done through comparing the sensor data with a corresponding threshold, where the corresponding environment is deemed to be unsafe if the threshold is reached or crossed. If the automation function environment 20 is deemed to be unsafe, i.e. if the safety is deemed to be insufficient, the safety control function 60 then performs a safety function using the first safety actuator 36, S220A.

In the second safety control loop, the second safety sensor 54 may continuously provide safety data to the safety control function 60, such as a measured physical property like temperature. The safety data may also here comprise data about detected temperature levels or temperature changes in the control signal path environment 49. The safety data may also or instead comprise data about detected smoke or fire in the environment 49, data about physical intrusion and/or damage to the environment and/or virtual intrusion detected by firewalls of the environment. The safety data may also comprise safety data concerning the operation of the wireless network 50, such as the operation of devices in the wireless network involved in the conveying of the control signals between the automation function environment 20 and the automation device 14 in the control signal path 48, such as devices in a base station through which the control signals pass. This safety data concerning operation of devices may more particularly comprise data about abnormal consumption of processing power and or memory resources. Thereby the safety control function 60 obtains safety data from the second safety sensor 54, S200B, which safety data concerns the safety of the environment 49 of at least a part of the control signal path 48. The safety control function then determines whether the corresponding control signal path environment 49 is safe, S210B. It thus determines the safety of the control signal path environment 49 based on the obtained safety data. The determination may also here be done through comparing the sensor data with a corresponding threshold, where the environment is deemed to be unsafe if the threshold is reached or crossed. If the environment 49 is deemed to be unsafe, i.e. the safety is deemed to be insufficient, the safety control function 60 then performs a safety function using the second safety actuator 51, S220B. This kind of operation may continuously be repeated as long as none of the environments 20, 49 are deemed to be unsafe.

The performing of a safety activity may involve stopping or rebooting hardware or software in the automation function environment 20 implementing the process control function and/or the hardware or software in the control signal path environment 49 if there is an abnormal consumption of processing power and/or memory resources. An abnormal consumption of processing power and/or memory resources may also lead to the activation of redundant/backup hardware and/or software. If the safety data concerns a too high temperature or a considerable increase in temperature, the safety activity may involve increasing ventilation or cooling of the environment. Alternatively, the safety activity may involve sending an alarm message to maintenance personnel. Also the detection of smoke, fire, physical intrusion and/or virtual intrusion may lead to the generation of alarm messages.

The safety control function may additionally perform a safety activity for the automation device 14 using a further safety actuator in case the safety of a corresponding environment is found to be insufficient. This latter safety activity may involve putting the automation device 14 in a safe state, which may be done through the wireless or wired safety actuator 66, 70.

It can be seen that through this realization of the safety control system, the functional safety is good even though process control is moved to the automation function environment 20.

It can also be seen that this good functional safety is obtained at the same time as the safety control system is based on traditional computing and communication technologies. It is thereby possible to keep a traditional safety control system when updating the process control system through placing process control in an automation function environment that controls an automation device via a wireless network.

The inclusion of safety sensors and actuators in the automation function environment and the control signal path environment into the safety control loop, guarantees safety integrity when these open and shared automation function environment and wireless network are involved in safety-critical industrial process control systems.

When the wired safety network 62 is connected to the wireless network 50 through the first type of second wireless network interface 64A and the automation device environment has two separate interfaces 16 and 18 for safety and process control traffic, respectively, it can be seen that a network for safety control formed by the wireless network 50 and the wired safety network 62 is hybrid (wired+one-hop wireless) which emphasizes the flexibility as well as reusability of the existing safety field devices. If instead the second type of second wireless network interface were to be used, the network for safety control is hybrid (wired+two-hop wireless).

If the wired safety network 62 is connected to the backbone of the wireless network 50 then the communication with the second safety sensor 54 and the second safety actuator 51 is fast. The speed of the communication with the first safety sensor 42 and the first safety actuator 36 may also be fast, which speed may increase further if also the automation function environment 20 is connected to the backbone network.

There are a number of variations that can be made of the first embodiment. For instance, it should be realised that it is possible to only perform one of the safety control loops. It is thus possible that only the first safety control loop or that only the second safety control loop is performed.

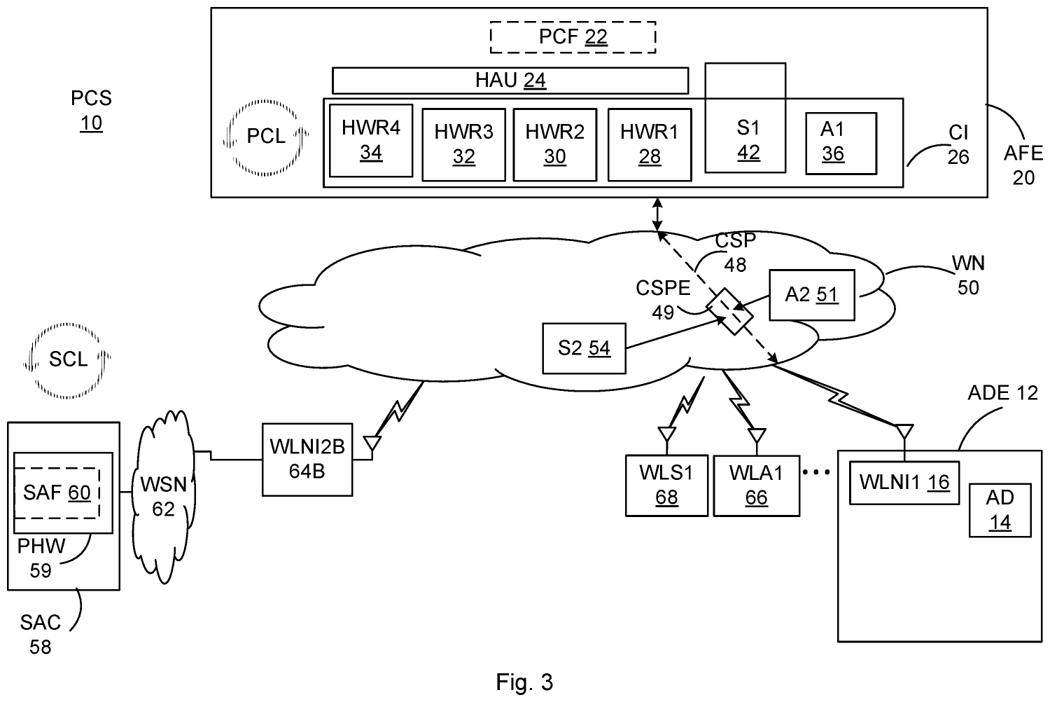

FIG. 3 schematically shows a second embodiment of the process control system 10. In this variation there are no wired safety field devices, only wireless safety field devices 66, 68. Consequently, also the automation device environment 12 lacks the first wired network interface. Moreover, in this case the wired safety network 62 is connected to the wireless network 50 through a second type of second wireless network interface WLNI2B 64B, which in this case is an air interface to the wireless network 50. The air interface may be realised through a radio circuit and antenna communicating wirelessly with a base station of the wireless network.

Furthermore, the automation device environment 12 has a single interface in the form of the first wireless network interface 16, which is used for both safety and process control traffic. In this embodiment, the network for safety control is almost fully wireless which can minimize the cabling in the field.

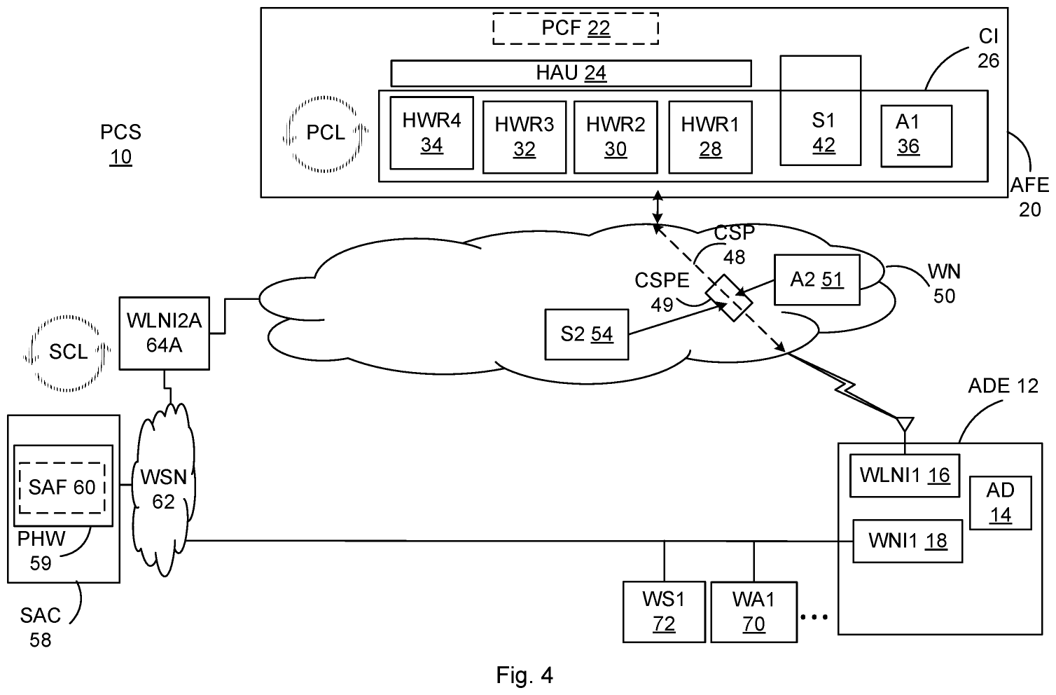

FIG. 4 schematically shows a third embodiment of the process control system 10. In this embodiment there are no wireless safety field devices, only wired safety field devices 70 and 72. Again the wired safety network 62 is connected to the wireless network 50 using the first type of second wireless network interface 64A and the automation device environment 12 includes a first wireless network interface 16 and a first wired network interface 18. In this embodiment, the network for safety control is almost fully wired which can maximize the reliability and minimize the latency of the safety control network.

The overall architecture of combining the traditional safety control with the process control in an automation function environment, guarantees the functional safety while enjoying the benefits of edge and cloud computing combined with wireless communication in industrial process control systems.

Furthermore, through the way that the safety control system is realized it is possible to reuse established functional safety technologies and practices, such as the safety controller software and hardware, safety logic design methods, safety sensors/actuators, and safety communication protocols. Also, the capital expenditure and technology barriers of customers to build and run the automation and safety systems are reduced. It is additionally possible to introduce/integrate novel services (such as data analytics).

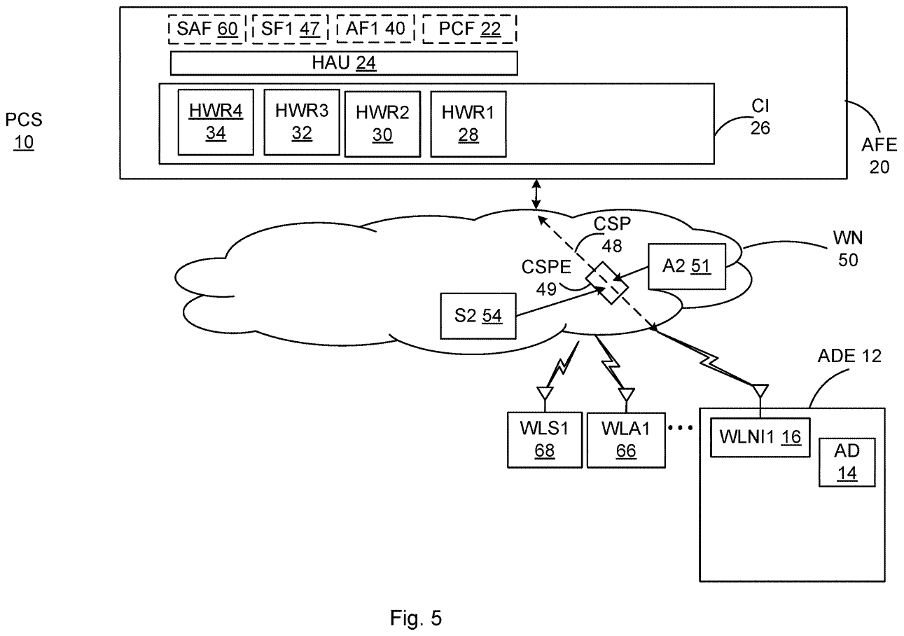

In the embodiments of the process control system described so far, the safety control function 60 was provided in a physical safety controller 58 locally near the automation device 14. It should however be realized that the safety control function 60 may just as well be placed in the automation function environment 20. One example of this is shown in FIG. 5.

It can here be seen that the safety control function 60 is placed in the automation function environment 20. Furthermore, it is also assigned a hardware resource by the first hardware assigning unit 24. Thereby the assigned hardware resource is also the primary hardware entity on which the safety control function is being run. Thereby the safety control function 60 is also realized on a separate virtual machine for instance as a virtual safety controller. It can also be seen that the first actuator function 40 and the first sensor function 47 are provided as functions run in virtual machines that are assigned to hardware resources by the first hardware assigning unit 24. They are in this case also realized on separate virtual machines. As an example, the first hardware resource 28 is assigned to the process control function 22, the second hardware resource 30 is assigned to the safety control function 60, the third hardware resource 32 is assigned to the first actuator function 40 and the fourth hardware resource 34 is assigned to the first sensor function 47. Thereby, the second hardware resource 30 forms the primary hardware entity provided for the safety control function 60, the fourth hardware resource 34 forms the first secondary hardware entity provided for the first sensor function 47 and the third hardware resource 32 forms the second secondary hardware entity provided for the first actuator function 36. Alternatively, the first sensor function and the first actuator function may be combined with the safety control function and performed on the first hardware resource 28.

To meet stringent dependability of safety applications, a dedicated safety certified hypervisor, such as the PikeOS from GOSYS, may be deployed on top of the infrastructure hardware. The safety logic is executed in the virtual safety controller which is deployed on top of the virtual machine.

It should here be realized that as an alternative, the safety control function, the first actuator function and the first sensor function could be provided using dedicated hardware instead.

In the wireless network 50, the second safety actuator 51 and the second safety sensor 54 may be realized as a second actuator function in dedicated hardware and as a second sensor function in dedicated hardware and communicating with a detector. It is also possible that these functions are assigned to hardware by the second hardware assigning unit in the wireless network, such as to hardware in a base station of the wireless network in the same way as in the automation function environment.

As an example, the communication protocol among the virtual safety controller and all the safety sensors and actuators may follow one of the standards defined in IEC 61784-3, including but not limited to PROFIsafe, openSAFETY, CIP Safety, FSoE, CC-Link IE Safety, OPC UA Safety, etc.

As in FIG. 3 there are no wired safety field devices. There is also no wired safety network, only a group of wireless safety field devices 66, 68. Consequently, the automation device environment 12 is not provided with any first wired network interface. It only has the first wireless network interface 16. The wireless safety field devices including the wireless safety sensor 68 and wireless safety actuator 66 are connected to and controlled by the safety control function 60 over the wireless network 50, which is qualified to elaborate the black channel for safety communication layer according to the IEC61508.

It can be seen in the last embodiment that the hardware safety controller has been eliminated, which is important to fully provide the promised benefits of Control-as-a-Service provided using cloud computing. The capital expenditure and technology barriers of customers to build and run the automation and safety systems is also even further reduced. At the same time the established functional safety technologies and practices, such as the safety controller software, safety logic design methods, safety sensors/actuators, and safety communication protocols can be reused to a large degree.

Since there is no field safety controller, the wireless safety actuator 66 may be triggered to safe state if it doesn't receive proper requests and or responses from the safety control function 60 for a certain amount of time (also called Watchdog Time), which implies some outage or congestion happens in the computing infrastructure 26 and/or the wireless network 50. The wireless safety actuator 66 may thus put the automation device 14 in a safe state if being unable to communicate with the safety control function 60.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

1. A process control system comprising:
an automation device;
an automation function environment comprising a process control function, a first hardware assigning unit and hardware for functions of the automation function environment, where the process control function controls the automation device using control signals sent in a control signal path through a wireless network and employing hardware in the automation function environment that has been assigned to the process control function by the first hardware assigning unit;
a group of safety field devices including at least one safety actuator and at least one safety sensor placed together in the automation function environment and/or in a control signal path environment in the wireless network; and
a primary hardware entity implementing a safety control function,
said safety control function being configured to obtain safety data from the at least one safety sensor about the safety of the corresponding environment, determine the safety of the corresponding environment based on the obtained safety data and perform a safety activity using the at least one safety actuator in case the safety of the corresponding environment is found to be insufficient.

2. The process control system according to claim 1, wherein the at least one safety sensor comprises a first safety sensor in the automation function environment and the at least one safety actuator includes a first safety actuator in the automation function environment.

3. The process control system according to claim 2, wherein a first secondary hardware entity is provided in the automation function environment for sensor handling functionality of the first safety sensor.

4. The process control system according to claim 2, wherein a second secondary hardware entity is provided in the automation function environment for actuator functionality of the first safety actuator.

5. The process control system according to claim 4, wherein each secondary hardware entity has been assigned to the sensor handling functionality or the actuator functionality by the first hardware assigning unit.

6. The process control system according to claim 1, the at least one safety sensor comprising a second safety sensor placed in the control signal path environment and the at least one safety actuator including a second safety actuator placed together with the second safety sensor in the control signal path environment.

7. The process control system according to claim 6, wherein a first tertiary hardware entity is provided in the control signal path environment for sensor handling functionality of the second safety sensor.

8. The process control system according to claim 6, wherein a second tertiary hardware entity is provided in the control signal path environment for actuator functionality of the second safety actuator.

9. The process control system according to claim 1, further comprising a wired safety network.

10. The process control system according to claim 9, wherein at least one further safety field device in the group of safety field devices is a wired safety field device connected to the wired safety network.

11. The process control system according to claim 1, wherein at least one further safety field device in the group of safety field devices is a wireless safety field device.

12. The process control system according to claim 1, further comprising a safety controller including the primary hardware entity implementing the safety function.

13. The process control system according to claim 1, wherein the primary hardware entity is provided in the automation function environment.

14. The process control system according to claim 13, wherein the primary hardware entity has been assigned to the safety function by the first hardware assigning unit.

15. A method for investigating safety in a process control system, the process control system having
an automation function environment in contact with an automation device via a wireless network, where a process control function in the automation function environment controls the automation device using control signals sent in a control signal path through the wireless network and employing hardware in the automation function environment that has been assigned to the process control function by a first hardware assigning unit; and
a group of safety field devices including at least one safety actuator and at least one safety sensor placed together in the automation function environment and/or in a control signal path environment in the wireless network;
the method comprising:
obtaining, from the at least one safety sensor, safety data about the safety of the corresponding environment;
determining the safety of the corresponding environment based on the obtained safety data; and
performing a safety activity using the at least one safety actuator in case the safety of the corresponding environment is found to be insufficient.

16. The process control system according to claim 3, wherein a second secondary hardware entity is provided in the automation function environment for actuator functionality of the first safety actuator.

17. The process control system according to claim 2, the at least one safety sensor comprising a second safety sensor placed in the control signal path environment and the at least one safety actuator including a second safety actuator placed together with the second safety sensor in the control signal path environment.

18. The process control system according to claim 7, wherein a second tertiary hardware entity is provided in the control signal path environment for actuator functionality of the second safety actuator.

19. The process control system according to claim 2, further comprising a wired safety network.

20. The process control system according to claim 2, wherein at least one further safety field device in the group of safety field devices is a wireless safety field device.
